(19) United States
(12) Patent Application Publication
(10) Pub. No.: US 2024/0216993 A1
(43) Pub. Date: Jul. 4, 2024

(54) Support Arrangement for Additive Manufacturing, Additive Manufacturing Device and Method of Producing Three-Dimensional Object

(71) Applicant: ABB Schweiz AG, Baden (CH)

(72) Inventors: Stefano Maranò, Zurich (CH); Ioannis Lymperopoulos, Dietikon (CH); Elisabet Capon, Zurich (CH); Andrea Cortinovis, Rieden (AG) (CH); Jacim Jacimovic, Wettingen (CH); Thorsten Strassel, Mülligen (CH); Robin Verschueren, Zürich (CH); Chau-Hon Ho, Lörrach (DE)

(21) Appl. No.: 18/554,267

(22) PCT Filed: Apr. 12, 2021
(86) PCT No.: PCT/EP2021/059407

§ 371 Date: Oct. 6, 2023

(51) Int. Cl. B22F 10/47; B22F 10/28; B22F 12/90; B33Y 10/00; B33Y 30/00; B33Y 50/02

(52) U.S. Cl. CPC B22F 10/47; B22F 10/28; B22F 12/90; B33Y 10/00; B33Y 30/00; B33Y 50/02

(57) ABSTRACT

A support arrangement for additive manufacturing, the support arrangement including a base structure; and a plurality of elongated support elements for supporting a three-dimensional object during additive manufacture of the three-dimensional object, each support element having a longitudinal axis and being independently movable relative to the base structure along the associated longitudinal axis; wherein at least one of the support elements is rotatable about the associated longitudinal axis. An additive manufacturing device including a support arrangement, and a method of producing a three-dimensional object, are also provided.

### TECHNICAL FIELD

The present disclosure generally relates to additive manufacturing. In particular, a support arrangement for additive manufacturing, an additive manufacturing device comprising a support arrangement, and a method of producing a three-dimensional object, are provided.

### BACKGROUND

Additive manufacturing (AM), also known as 3D printing, is a manufacturing method which is implemented in a wide range of industries. When producing a three-dimensional object by means of additive manufacturing, support structures are commonly used. The support structures are printed in the same way as the three-dimensional object. The support structures may serve at least two purposes: i) to support the weight of the three-dimensional object or parts thereof, and ii) for heat dissipation during the additive manufacturing process.

Support structures are however associated with some drawbacks. Examples of such drawbacks include an increased material cost, a longer printing time, and a need for post-processing to remove the support structures from the three-dimensional object. In some applications, the amount of material used for the support structures is almost the same as the amount of material used for the three-dimensional object itself. Clearly, this significantly lengthens the printing time and thereby reduces the effective utilization rate of the additive manufacturing device, which is typically very expensive. The post-processing also increases costs and risks to damage the surface of the finished three-dimensional object. Furthermore, manual post-processing is arduous and increases the cost of the final three-dimensional object. For these reasons, it is desired to minimize the size, number and printing time of the support structures.

US 2019381733 A1 discloses a device for the additive manufacturing of a shaped body comprising a process chamber for a material for making the shaped body and a plurality of bar elements defining at least a partial region of the process chamber. Each of the plurality of bar elements is movable in relation to one another. A sensor associated with at least one of the plurality of bar elements is provided to detect forces and/or torques acting on the at least one bar element.

### SUMMARY

One object of the present disclosure is to an improved support arrangement for additive manufacturing.

A further object of the present disclosure is to provide a support arrangement for additive manufacturing, which support arrangement enables an improved additive manufacturing process.

A still further object of the present disclosure is to provide a cost-efficient support arrangement for additive manufacturing.

A still further object of the present disclosure is to provide a support arrangement for additive manufacturing, which support arrangement facilitates removal of a three-dimensional object from a base structure.

A still further object of the present disclosure is to provide a support arrangement for additive manufacturing, which support arrangement enables a consumption of printing material to be reduced.

A still further object of the present disclosure is to provide a support arrangement for additive manufacturing, which support arrangement enables an accurate support of a three-dimensional object during additive manufacturing.

A still further object of the present disclosure is to provide a support arrangement for additive manufacturing, which support arrangement solves several or all of the foregoing objects in combination.

A still further object of the present disclosure is to provide an additive manufacturing device comprising a support arrangement, which additive manufacturing device solves one, several or all of the foregoing objects.

A still further object of the present disclosure is to provide a method of producing a three-dimensional object, which method solves one, several or all of the foregoing objects.

According to a first aspect, there is provided a support arrangement for additive manufacturing, the support arrangement comprising a base structure; and a plurality of elongated support elements for supporting a three-dimensional object during additive manufacture of the three-dimensional object, each support element having a longitudinal axis and being independently movable relative to the base structure along the associated longitudinal axis; wherein at least one of the support elements is rotatable about the associated longitudinal axis.

By means of the support elements being movable along the respectively associated longitudinal axis, printed support structures can be made smaller or can be eliminated. As a consequence, a consumption of printing material can be reduced. The support structures are sacrificial. That is, the support structures are not included in the targeted design of the three-dimensional object.

By rotating the at least one support element about the associated longitudinal axis, a contact between the support element and the three-dimensional object, such as a contact between the support element and a support structure, can be broken in a controlled way. The rotational capability of the at least one support element thereby enables a controlled removal of the three-dimensional object from the support arrangement. Due to the controlled breakage caused by the rotation of one or more of the support elements, the sizes of the support structures can be further reduced. Without such rotation, there is a risk that the three-dimensional object is damaged during removal or that more extensive post-processing is needed.

The rotational capability of the at least one support element also facilitates movement of the support element along the associated longitudinal axis through a powder. Furthermore, in case a support element having an asymmetric head is rotated, the rotation enables the head to better match a shape of the three-dimensional object. In this way, consumption of material for support structures can be further reduced.

The base structure and the support elements form an adaptable baseplate for additive manufacturing. The support elements may be electrically and/or mechanically controlled to move relative to the base structure.

All support elements may be parallel. Alternatively, or in addition, the support elements may be supported on a common baseplate constituting the base structure. The support elements may be spaced from each other. The support elements may be made of metal.

Throughout the present disclosure, a movement of a support element along its longitudinal axis is referred to as a translational movement. The support arrangement may comprise one or more actuators for effecting the translational and rotational movements of the support elements.

The additive manufacturing of the three-dimensional object and any support structures therefor may be performed by means of a wide range of additive manufacturing devices. Examples include selective laser sintering (SLS), selective laser melting (SLS), fused deposition modeling (FDM), stereolithography apparatus (SLA) and other material jetting technologies. The forming may comprise repeatedly forming a solidified layer by irradiating a predetermined portion of a powder layer with a light beam, thereby allowing a sintering of the powder in the predetermined portion or a melting and subsequent solidification thereof, and forming another solidified layer by newly forming a powder layer on the resulting solidified layer, followed by the irradiation of a predetermined portion of the metal powder layer with the light beam. The powder may comprise metal, ceramics and/or plastics.

The at least one rotatable support element may comprise a head. The head may be flat round or have a shape to better match the three-dimensional object. According to one variant, the head is asymmetric with respect to the associated longitudinal axis.

The head may comprise a coating. The coating may be electrically insulating. The coating may be made of a refractory material, such as ceramic. The coating reduces the risk of the three-dimensional object or support structures to become stuck on the support elements.

A plurality of the support elements may be independently rotatable about the respective associated longitudinal axes. The support elements may be arranged in a matrix. In some variants, all support elements are independently rotatable about the respective associated longitudinal axis.

The support arrangement may further comprise one or more temperature sensors configured to provide temperature data indicative of a temperature in one or more of the support elements. By providing temperature data from the support elements in this way, expansions of the one or more support elements due to a raised temperature can be calculated. This in turn enables the support elements to be more accurately positioned. Each temperature sensor may be arranged inside an associated support element. According to one example, all support elements comprise such temperature sensor.

Each support element may comprise an elongated distal part for supporting the three-dimensional object and an elongated proximal part supporting the distal part, the distal part being releasable from the proximal part. In this case, the distal part is arranged closer to the three-dimensional object than the proximal part.

In this variant, each support element may further comprise a coupling for selectively coupling the distal part to the proximal part. The coupling may be an electromagnetic coupling. The coupling may be arranged inside the associated support element.

The support arrangement may further comprise an intermediate structure having a through hole associated with each support element. In this case, at least a part of the intermediate structure may be configured to be removed from the base structure.

The support arrangement may further comprise a locking device associated with each support element. In this case, each locking device may be configured to be engaged for locking the distal part to the intermediate structure. By means of the locking devices, the distal parts can be held in position relative to the intermediate structure when the intermediate structure is removed from the base structure. Each locking device may comprise an electropermanent magnet for selectively applying a magnetic force on the associated support element for locking the distal part to the intermediate structure. The locking devices may be arranged in the support elements or in the intermediate structure.

The intermediate structure may be modular. The intermediate structure may comprise a plurality of intermediate structure units. Each intermediate structure unit may comprise one or several support elements according to the present disclosure. The modular intermediate structure enables one or several intermediate structure units to be removed, such as taken out from a production chamber, for post-processing while one or several intermediate structure units remain on the base structure. In case the support arrangement of this variant also comprises the locking devices, the distal parts can be held in position relative to the associated intermediate structure unit when the intermediate structure unit is taken out from the production chamber.

In case the support arrangement comprises actuators for effecting the translational and rotational movements of the support elements, the actuators may remain in the base structure when one or more intermediate structure units are lifted out.

According to a second aspect, there is provided an additive manufacturing device comprising a support arrangement according to the first aspect. The additive manufacturing device may for example be a powder bed printer or a material jetting printer.

The additive manufacturing device may further comprise a control system having at least one data processing device and at least one memory having a computer program stored thereon, the computer program comprising program code which, when executed by the at least one data processing device, causes the at least one data processing device to perform the steps of receiving temperature data from the one or more temperature sensors; and controlling movements of the support elements based on the temperature data. In particular, translational movements of the support elements may be controlled based on the temperature data. For example, a support element may be commanded to translate a relatively short distance for a relatively high temperature in the support element, and may be commanded to translate a relatively long distance for a relatively low temperature in the support element.

According to a third aspect, there is provided a method of producing a three-dimensional object, the method comprising providing a support arrangement comprising a base structure and a plurality of elongated support elements for supporting the three-dimensional object, each support element having a longitudinal axis and being independently movable relative to the base structure along the associated longitudinal axis; forming the three-dimensional object on the support elements by means of additive manufacturing in an additive manufacturing process; moving one or more of the support elements along the associated longitudinal axis during the additive manufacturing process; and rotating at least one of the support elements about the associated longitudinal axis. The method according to the third aspect may employ a support arrangement of any type according to the first aspect, and vice versa. The method may comprise rotating at least one of the support elements about the longitudinal axis during and/or after the additive manufacturing process.

The method may further comprise forming one or more support structures on the support element by means of additive manufacturing. The three-dimensional object may then be formed on the support structures. By moving some or all of the support elements closer to the position where the three-dimensional object will be printed, the support structures can be made smaller and printing material consumption can be reduced.

The method may further comprise providing a machine learning agent, and controlling the rotation of the at least one support element by means of the machine learning agent. The machine learning agent may be configured to improve the rotation of the at least one support element, e.g. such as to not generate cracks.

The at least one support element may be rotated to break a connection between the support element and the three-dimensional object, such as a connection between the support element and support structures for the three-dimensional object.

The support arrangement may further comprise one or more temperature sensors configured to provide temperature data indicative of a temperature in one or more of the support elements. In this case, the method may further comprise controlling movements of the support elements based on the temperature data. The method may comprise determining a thermal expansion for each support element based on the temperature data, and controlling translational movements of the support elements based on the thermal expansions.

Each support element may comprise an elongated distal part for supporting the three-dimensional object and an elongated proximal part supporting the distal part, the distal part being releasable from the proximal part. In this case, the method may further comprise releasing one or more of the distal parts from the associated one or more proximal parts; and removing the three-dimensional object together with the one or more released distal parts from the base structure.

The support arrangement may further comprise an intermediate structure having a through hole associated with each support element. In this case, the method may further comprise removing the three-dimensional object together with at least a part of the intermediate structure from the base structure.

The intermediate structure may be modular and may comprise a plurality of intermediate structure units. In this case, the method may further comprise removing the three-dimensional object together with one or more of the intermediate structure units from the base structure.

The at least one support element may be simultaneously moved along, and rotated about, the associated longitudinal axis during the additive manufacturing process. This simultaneous translational and rotational movement of the support element may be carried out during the additive manufacturing process between the printing of two layers.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an additive manufacturing device comprising a support arrangement;

FIG. 2: schematically represents a side view of the support arrangement;

FIG. 3: schematically represents a partial cross-sectional side view of the support arrangement;

FIG. 4: schematically represents a top view of the support arrangement;

FIG. 5: schematically represents a side view of the support arrangement and a printed three-dimensional object;

FIG. 6: schematically represents a side view of the additive manufacturing device during printing of support structures;

FIG. 7: schematically represents a side view of the additive manufacturing device during movement of support elements;

FIG. 8: schematically represents a side view of the additive manufacturing device during printing of the three-dimensional object;

FIG. 9: schematically represents a side view of the additive manufacturing device during further movement of the support elements;

FIG. 10: schematically represents a side view of the additive manufacturing device during further printing of the three-dimensional object;

FIG. 11: schematically represents a side view of the additive manufacturing device when the printing of the three-dimensional object is finished;

FIG. 12: schematically represents a side view of the additive manufacturing device during rotation of the support elements;

FIG. 13: schematically represents a side view of the additive manufacturing device during removal of the three-dimensional object; and

FIG. 14: schematically represents a side view of the additive manufacturing device during removal of the three-dimensional object together with intermediate structure units.

### DETAILED DESCRIPTION

In the following, a support arrangement for additive manufacturing, an additive manufacturing device comprising a support arrangement, and a method of producing a three-dimensional object, will be described. The same or similar reference numerals will be used to denote the same or similar structural features.

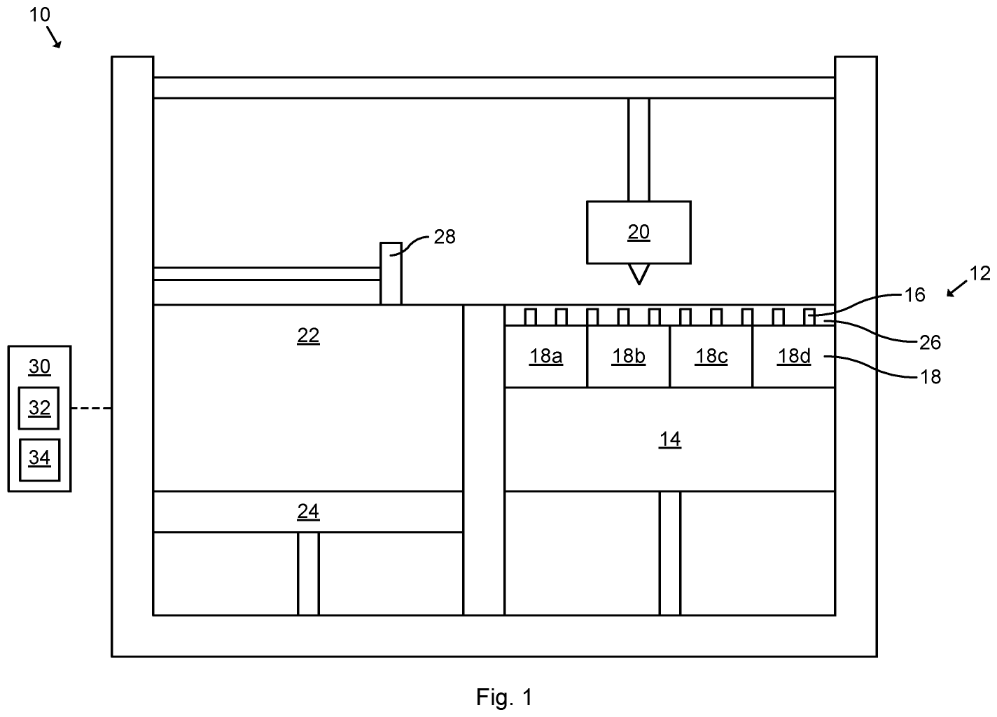

FIG. 1 schematically represents a side view of an additive manufacturing device 10. The additive manufacturing device 10 comprises a support arrangement 12. The support arrangement 12 comprises a baseplate 14 and a plurality of elongated support elements 16. The baseplate 14 is one example of a base structure according to the present disclosure. The support elements 16 are configured to support a three-dimensional object (not shown) during printing thereof by the additive manufacturing device 10. The support elements 16 are here exemplified as cylindrical pins.

The support arrangement 12 of this example further comprises an intermediate structure 18. The intermediate structure 18 is positioned on the baseplate 14. The intermediate structure 18 of this example is modular and comprises a plurality of intermediate structure units 18a-18d. Each intermediate structure unit 18a-18d can be lifted away from the baseplate 14.

The additive manufacturing device 10 of this specific example further comprises a printing head 20, such as a laser source, a material reservoir 22, a delivery piston 24 in the material reservoir 22, a production chamber 26 and a leveling mechanism 28.

The baseplate 14, the intermediate structure 18 and the support elements 16 are positioned in the production chamber 26. The baseplate 14 can be moved vertically up and down inside the production chamber 26 by a drive (not illustrated), such as a rack and pinion drive.

By moving the delivery piston 24 upwards and moving the leveling mechanism 28 horizontally, new material, here exemplified as metal powder, can be introduced to the production chamber 26. Movements of the printing head 20 may be controlled by a manipulator, such as a robotic manipulator or a CNC (computer numerical control) machine.

The additive manufacturing device 10 of this example is a powder bed deposition printing device. By means of powder bed deposition printing, the quality of the three-dimensional object is increased in comparison with for example laser melting deposition printing. The additive manufacturing device 10 in FIG. 1 is however only one of many examples. The additive manufacturing device 10 does for example not need to comprise a production chamber 26.

The additive manufacturing device 10 further comprises a control system 30. The control system 30 comprises a data processing device 32 and a memory 34. The memory 34 has a computer program stored thereon which, when executed by the data processing device 32, causes the data processing device 32 to perform, and/or command performance of, various steps as described herein. The control system 30 of this example is in signal communication with the support arrangement 12, the drive of the baseplate 14, the printing head 20, the delivery piston 24 and the leveling mechanism 28.

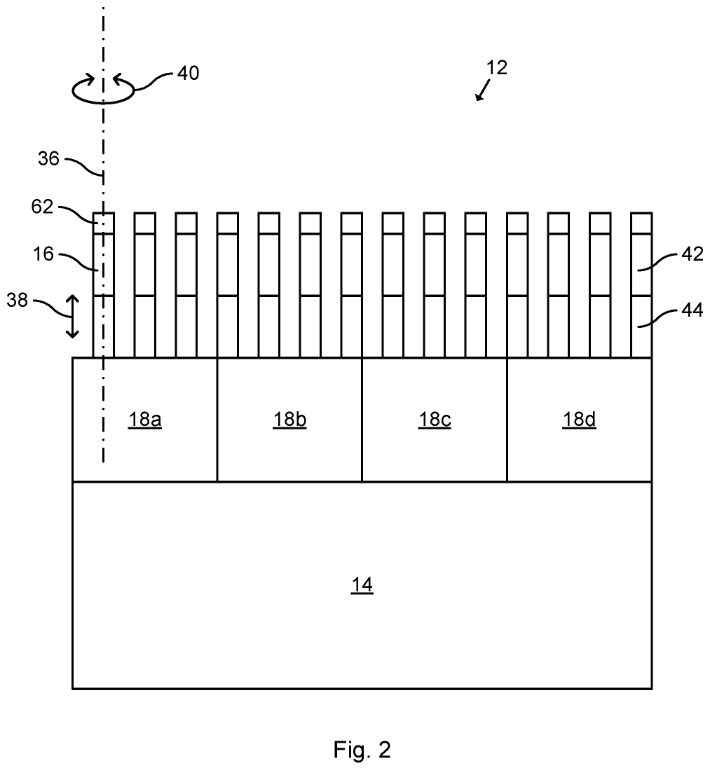

FIG. 2 schematically represents a side view of the support arrangement 12. Each support element 16 comprises a longitudinal axis 36. Each support element 16 is translationally movable along the associated longitudinal axis 36, as illustrated with arrow 38. In addition, each support element 16 is rotationally movable about the associated longitudinal axis 36, as illustrated with arrow 40.

All support elements 16 are parallel and spaced from each other. The support elements 16 are here made of metal.

In this example, each support element 16 comprises an elongated distal part 42 and an elongated proximal part 44. The distal part 42 supports the three-dimensional object and the proximal part 44 supports the distal part 42. In the orientation of the support element 16 in FIG. 2, the distal part 42 is arranged above the proximal part 44.

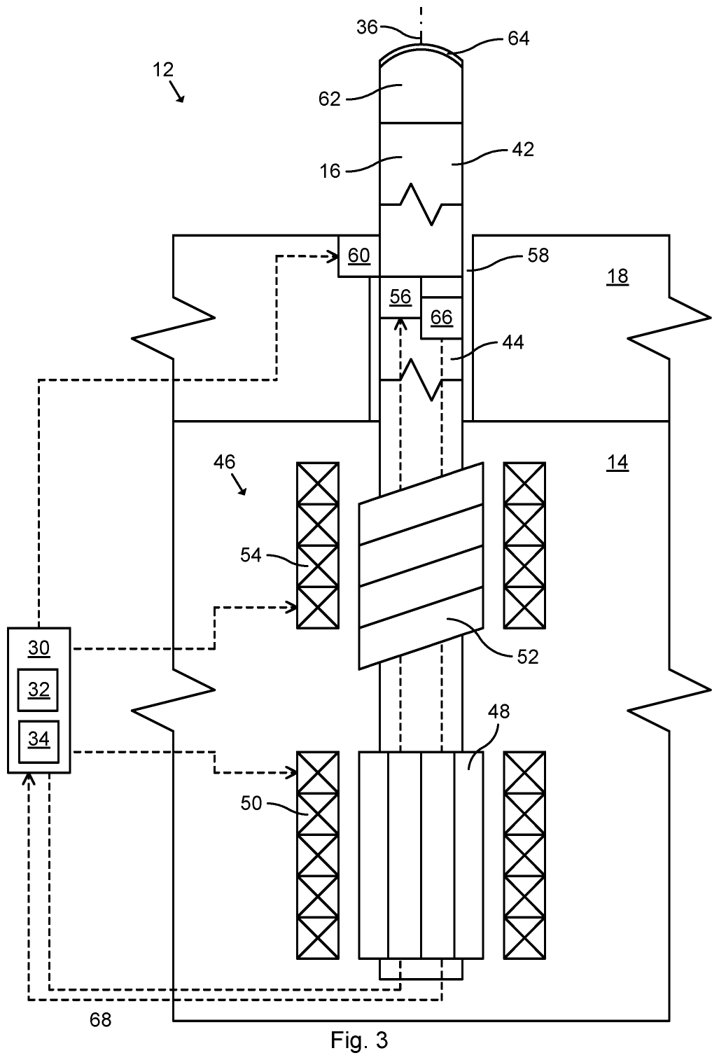

FIG. 3 schematically represents a partial cross-sectional side view of the support arrangement 12. In FIG. 3, only one of the support elements 16 is shown. The following description of the shown support element 16 however applies to each support element 16 of the support arrangement 12.

The support arrangement 12 comprises an actuator 46 associated with each support element 16. The actuator 46 is configured to independently effect translational movement of the support element 16 along the longitudinal axis 36 and rotational movement of the support element 16 about the longitudinal axis 36. The rotational movements and the translational movements of the support elements 16 occur relative to the baseplate 14.

The actuators 46 of this example are arranged in the baseplate 14. Each actuator 46 of this example comprises rotation permanent magnets 48, a rotation coil 50 wound around the rotation permanent magnets 48, translation permanent magnets 52 and a translation coil 54 wound around the translation permanent magnets 52.

The rotation permanent magnets 48 are straight and parallel with the longitudinal axis 36. The translation permanent magnets 52 are annular and inclined relative to the longitudinal axis 36. The rotation permanent magnets 48 and the translation permanent magnets 52 are fixed to the support element 16, here to the proximal part 44 thereof. The rotation coil 50 and the translation coil 54 are fixed to the baseplate 14.

The control system 30 is configured to send current pulses through each of the rotation coil 50 and the translation coil 54. By sending a current pulse through the rotation coil 50, the support element 16 rotates about the longitudinal axis 36. By sending a current pulse through the translation coil 54, the support element 16 translates along the longitudinal axis 36.

Forces acting on the support element 16 can be determined based on current drains from the actuator 46. In this way, no dedicated force sensors are needed for determining forces acting on the support element 16.

The support arrangement 12 of this example thus comprises one such actuator 46 for each support element 16. All support elements 16 can therefore rotate and translate independently. One support element 16 may thus translate along the associated longitudinal axis 36 while not rotating at the same time as another support element 16 rotates about the associated longitudinal axis 36 while not translating. The actuator 46 shown in FIG. 3 is one of many examples of an actuator 46 for effecting translational and rotational movements of the support element 16.

The support arrangement 12 of this example further comprises a coupling 56 associated with the support element 16, here exemplified as an electromagnetic coupling inside the proximal part 44. The coupling 56 can adopt a coupled state, where the distal part 42 is coupled to the proximal part 44 by the coupling 56, and a decoupled state, where the distal part 42 can be released from the proximal part 44. The coupling 56 is controlled by the control system 30.

As shown in FIG. 3, the intermediate structure 18 comprises a through hole 58. The through hole 58 extends through the intermediate structure 18 in parallel with the support element 16. The support element 16 can translate and rotate inside the through hole 58.

The support arrangement 12 of this example further comprises a locking device 60 associated with the support element 16, here exemplified as an electropermanent magnet in the intermediate structure 18 outside the support element 16. The locking device 60 can adopt a locking state, where the distal part 42 is locked to the intermediate structure 18 by the locking device 60, and an unlocking state, where the distal part 42 is unlocked from the intermediate structure 18. The locking device 60 is controlled by the control system 30. When the locking device 60 adopts the locking state, the distal part 42 can be held in position relative to the intermediate structure 18 when the intermediate structure 18 is removed from the baseplate 14.

The support element 16 comprises a head 62. The head 62 of this example has a spherical shape. The head 62 is provided with a coating 64. The coating 64 is provided as a thin layer on top of the head 62. The coating 64 comprises an electrically insulating and heat conducting ceramic material. The ceramic material ensures that heat from the laser deposition is dissipated through the coating 64 and also reduces the risk that powder is melted and soldered onto the coating 64.

The support arrangement 12 of this example further comprises a temperature sensor 66 associated with each support element 16. The temperature sensor 66 is configured to send temperature data 68 indicative of a temperature in the support element 16 to the control system 30. The temperature sensor 66 is here positioned inside the support element 16, more specifically in the proximal part 44. By means of the temperature sensor 66 inside the support element 16, thermal expansions of the support element 16 can be accurately determined despite the support element 16 being submerged in powder in the production chamber 26.

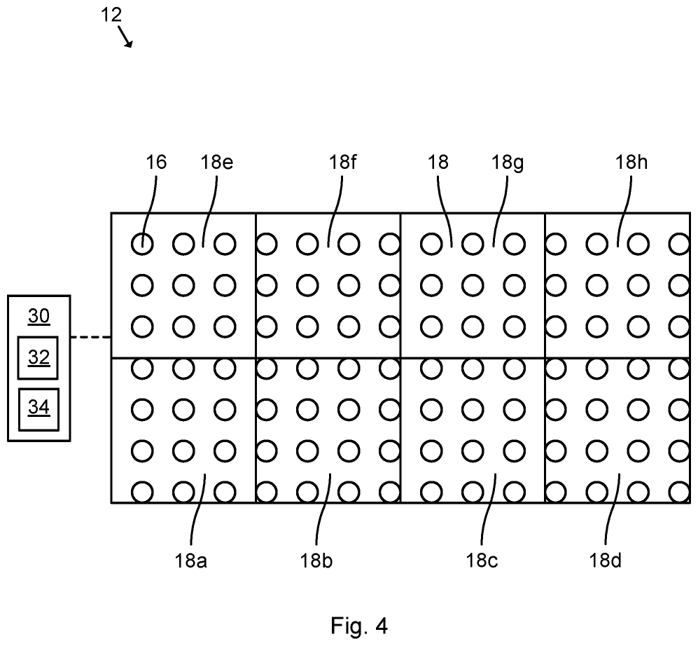

FIG. 4 schematically represents a top view of the support arrangement 12. As shown in FIG. 4, the support elements 16 are arranged in a matrix in this example.

The intermediate structure 18 of this example comprises eight intermediate structure units 18a-18h. Each intermediate structure unit 18a-18h comprises a plurality of the support elements 16. The intermediate structure 18 is modular meaning that each intermediate structure unit 18a-18h can be independently removed from the baseplate 14.

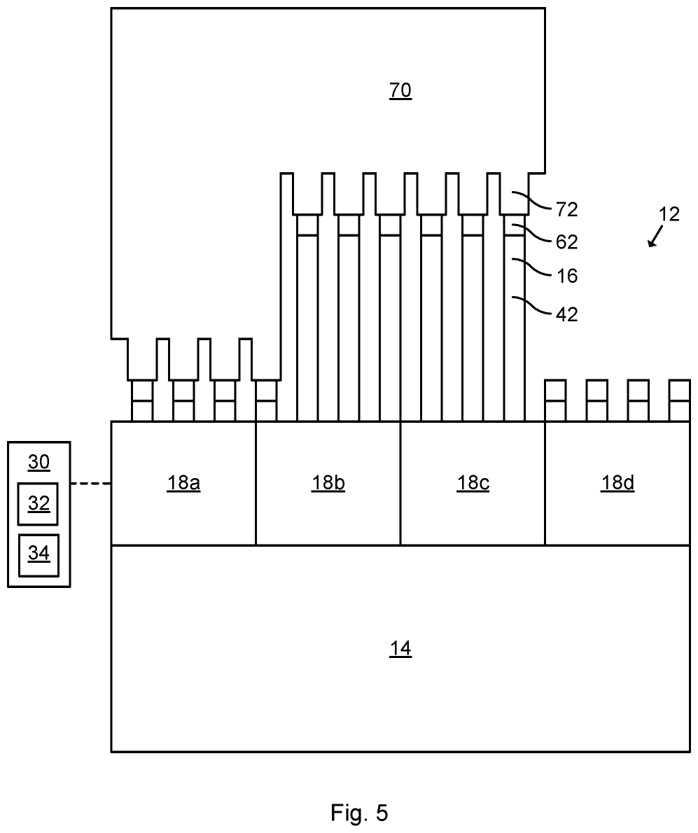

FIG. 5 schematically represents a side view of the support arrangement 12 and a printed three-dimensional object 70. FIG. 5 further shows a plurality of sacrificial support structures 72. The support structures 72 are printed by the additive manufacturing device 10 in the same way as the three-dimensional object 70. The support structures 72 support the three-dimensional object 70 during printing thereof and transfer heat from the laser printing process away from the three-dimensional object 70.

As shown in FIG. 5, the support elements 16 are lifted to match the shape of the three-dimensional object 70. The baseplate 14 therefore constitutes an adaptable baseplate.

In traditional support arrangements, the support structures 72 are printed all the way between the baseplate 14 and the three-dimensional object 70. By raising some of the support elements 16 along the associated longitudinal axis 36 to a desired height as shown in FIG. 5, the volumes required for the support structures 72 can be reduced in a simple, reliable and safe manner. As a consequence, an amount of printing material for the support structures 72 can be reduced and the printing time can be shortened. The shortening of the printing time in turn enables a utilization rate of the additive manufacturing device 10 to be increased.

Prior to starting the additive manufacturing process, the control system 30 calculates positions and movements of the support elements 16 for the additive manufacturing process based on the shape of the three-dimensional object 70 to be printed.

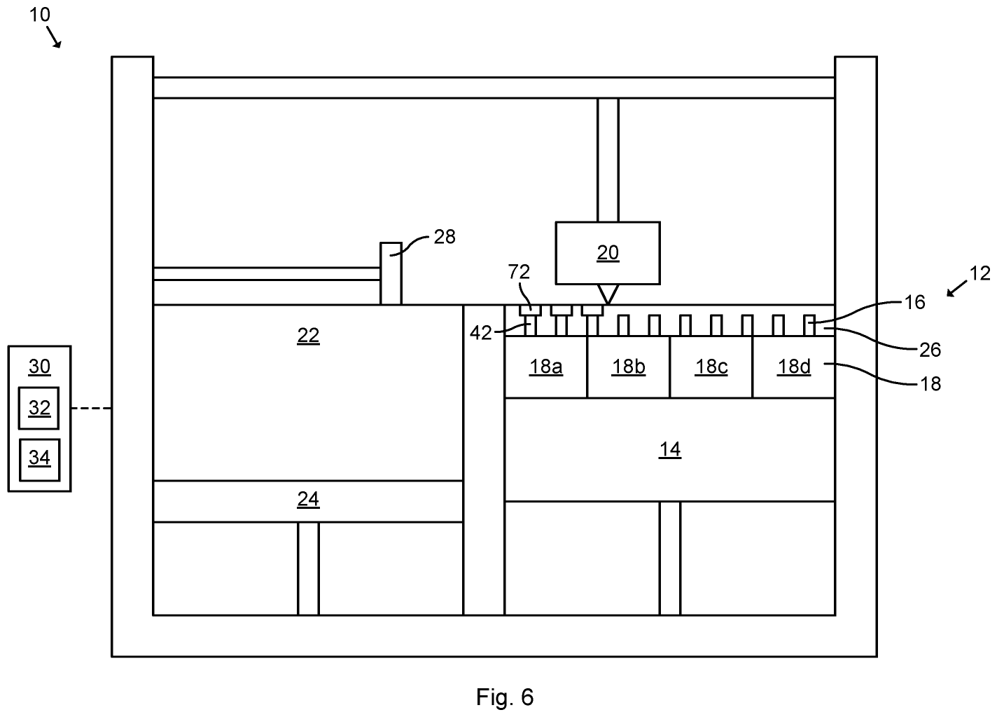

FIG. 6 schematically represents a side view of the additive manufacturing device 10 during printing. In FIG. 6, some of the support structures 72 for the three-dimensional object 70 are initially printed.

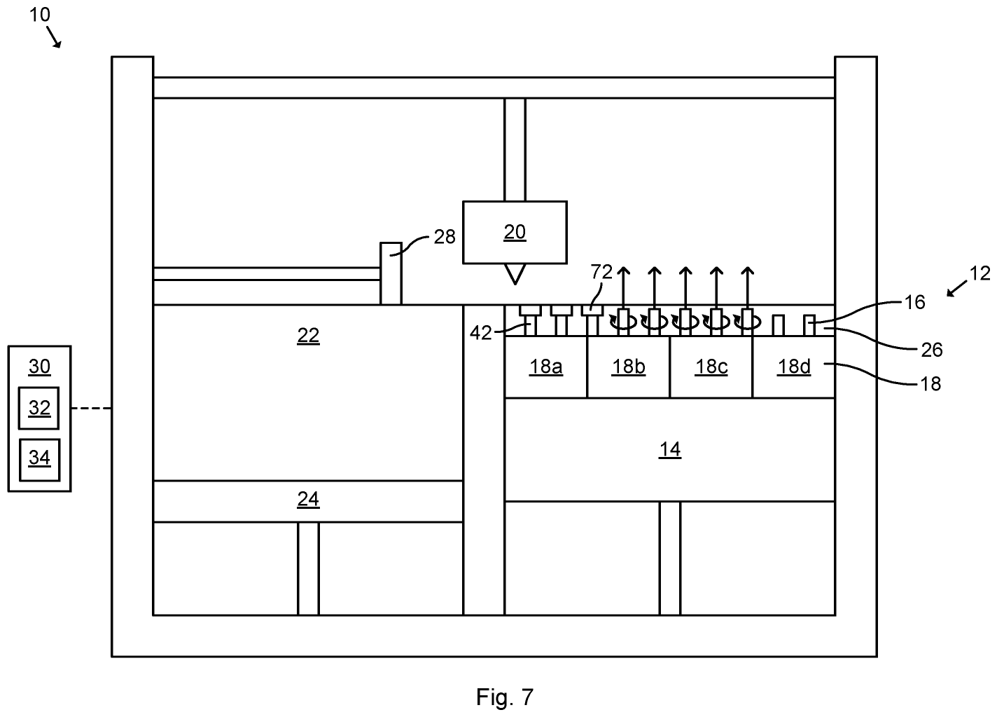

FIG. 7 schematically represents a side view of the additive manufacturing device 10 during movement of support elements 16. Between the printing of two layers, some of the support elements 16 are simultaneously translated upwards and rotated in a clockwise direction (as seen from above). This simultaneous translation and rotation facilitate penetration through the powder while maintaining the upper powder surface even.

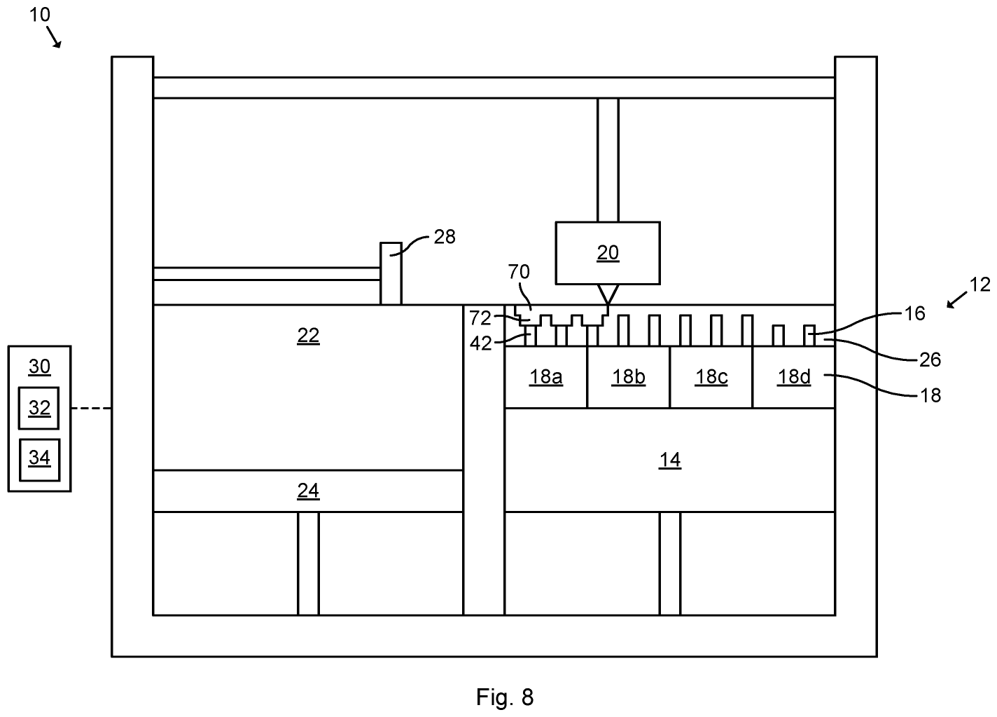

FIG. 8 schematically represents a side view of the additive manufacturing device 10 during printing of the three-dimensional object 70. In FIG. 8, the printing of some of the support structures 72 is completed and the printing of the three-dimensional object 70 on the support structures 72 has begun. In FIG. 8, the baseplate 14 has been lowered and a new layer of powder has been applied in the production chamber 26 by the leveling mechanism 28.

The baseplate 14 is incrementally lowered during the additive manufacturing process, i.e. between the printing steps thereof. During each actual printing step, the baseplate 14 and the support elements 16 are stationary.

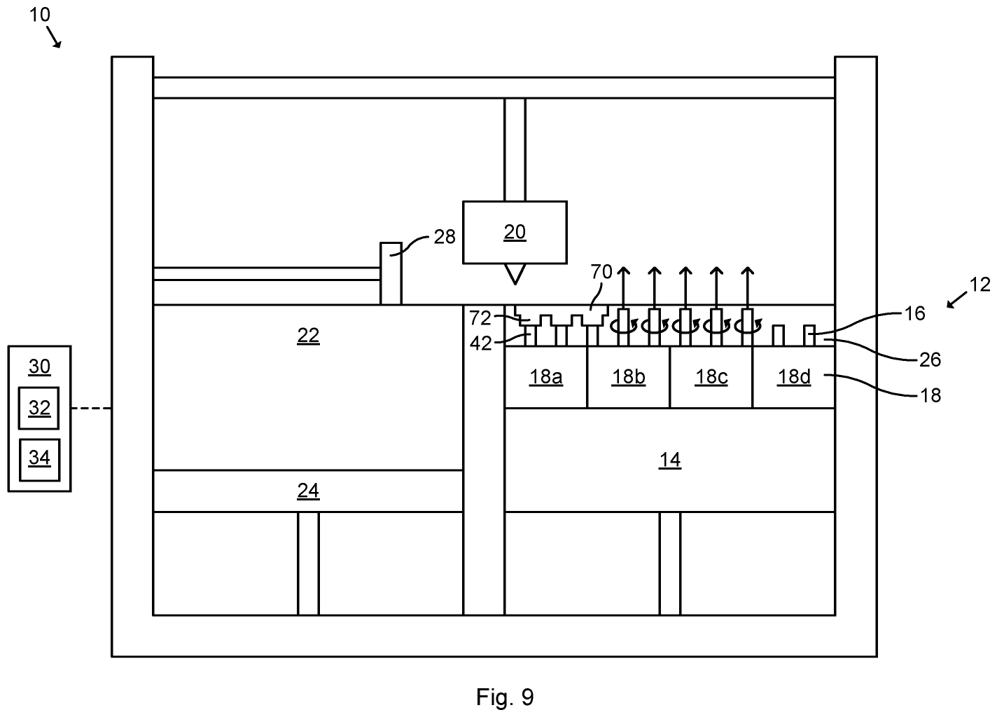

FIG. 9 schematically represents a side view of the additive manufacturing device 10 during further movement of the support elements 16. Between the printing of two layers, some of the support elements 16 are now simultaneously translated upwards and rotated in a counterclockwise direction (as seen from above). The support elements 16 are thus alternatingly rotated in clockwise and counterclockwise directions between the printing of layers. The support elements 16 are thereby lifted gradually so as to not interfere with the new uppermost layer of powder in the production chamber 26, as provided by the leveling mechanism 28. By rotating the support elements 16 at the same time as the support elements 16 translate through the powder, the upper surface of the powder in the production chamber 26 can be kept more smooth.

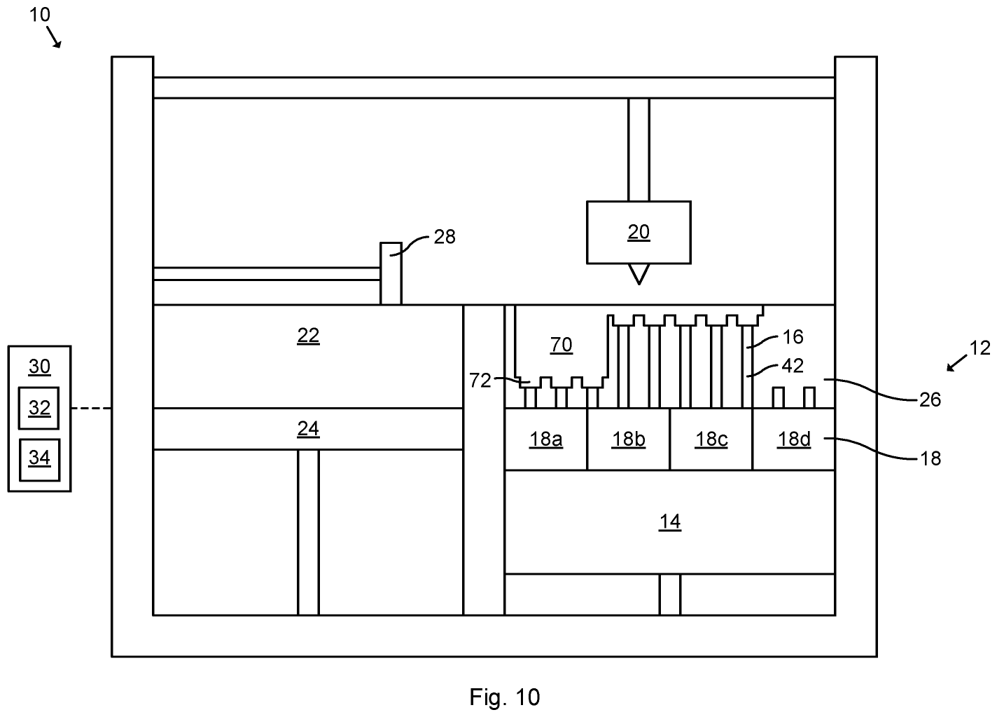

FIG. 10 schematically represents a side view of the additive manufacturing device 10 during further printing of the three-dimensional object 70. As shown in FIG. 10, the additive manufacturing device 10 has now printed further support structures 72 on the support elements 16.

The control system 30 continuously monitors the temperatures in the support elements 16 based on the temperature data 68 from the temperature sensors 66 and takes into account any thermal expansion of the support elements 16 for the translational movement control of the support elements 16. In this way, the precomputed positions and movements of the support elements 16 can be matched exactly despite thermal expansion.

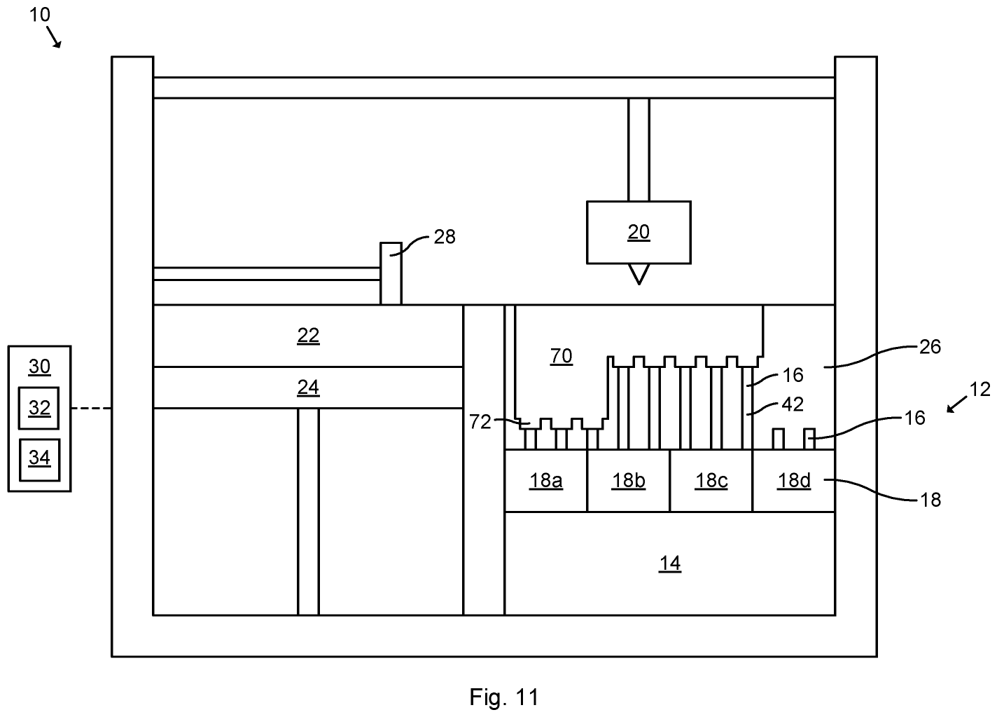

FIG. 11 schematically represents a side view of the additive manufacturing device 10 when the printing of the three-dimensional object 70 is finished. As shown in FIG. 11, the support elements 16 of the intermediate structure unit 18d remain passive throughout the additive manufacturing process.

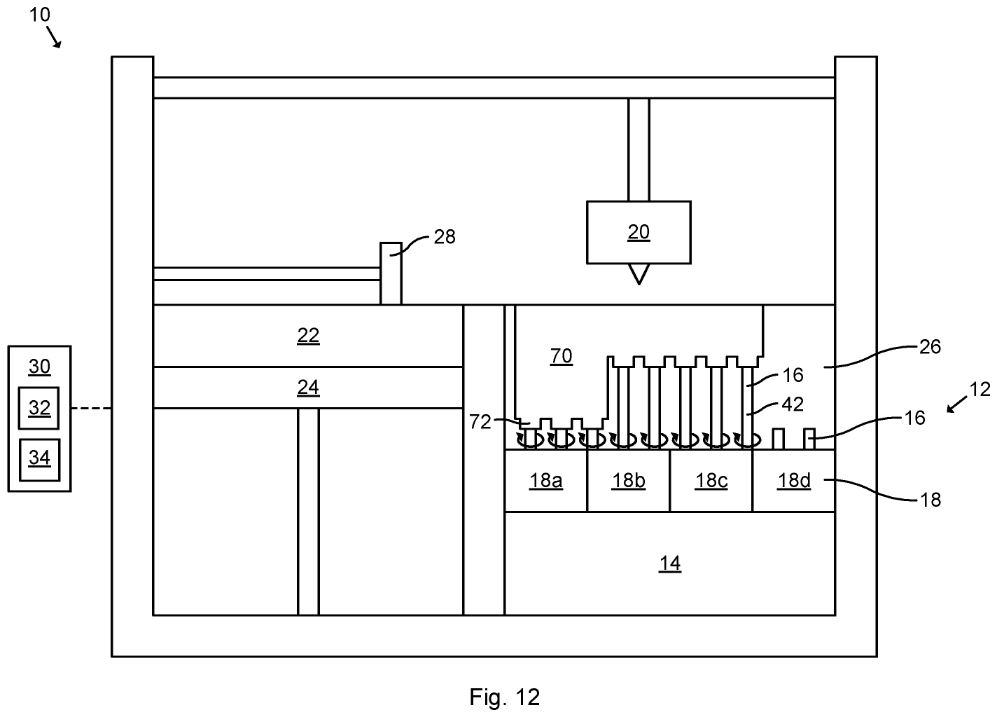

FIG. 12 schematically represents a side view of the additive manufacturing device 10 during rotation of the support elements 16. By rotating the support elements 16, any mechanical connection between the support elements 16 and the three-dimensional object 70 is broken in a controlled manner. In FIG. 12, any mechanical connections between the support structures 72 and the support elements 16 are broken by rotation of the support elements 16. As shown in FIG. 12, the support elements 16 can however still support the three-dimensional object 70 thereon. Due to the ceramic coatings 64 of the support elements 16, the rotational forces needed to break the connections are reduced.

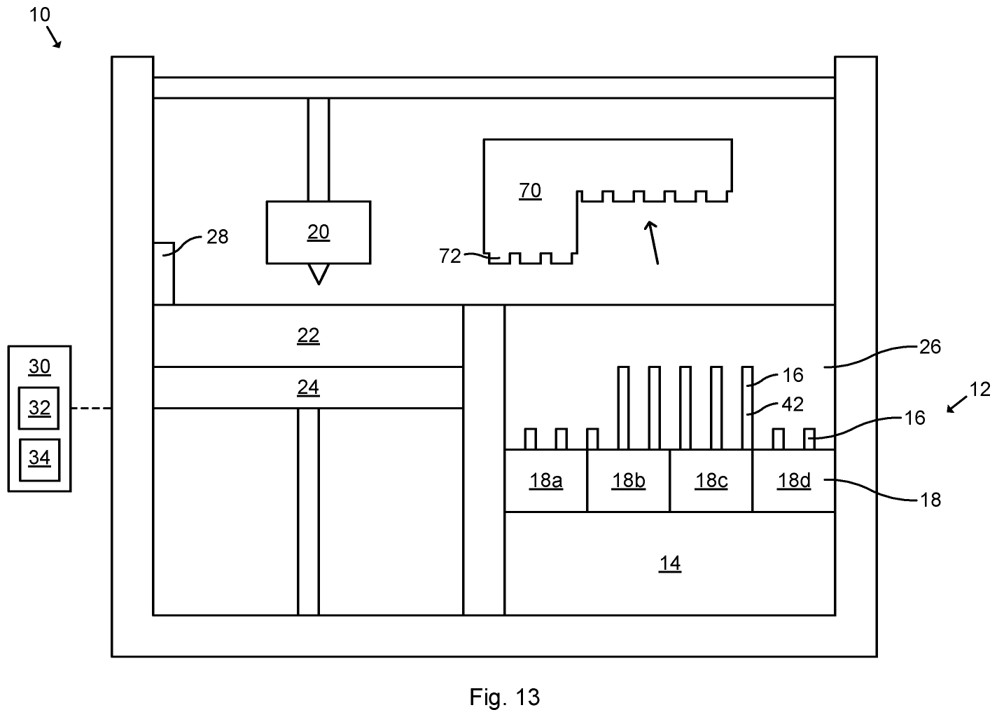

FIG. 13 schematically represents a side view of the additive manufacturing device 10 during removal of the three-dimensional object 70. Since the mechanical contacts between the support elements 16 and the three-dimensional object 70 are broken and the support structures 72 are not soldered onto the support elements 16, the three-dimensional object 70 can easily be lifted out from the production chamber 26. The rotation of the support elements 16 thus greatly facilitates removal of the finished three-dimensional object 70. The three-dimensional object 70 can be lifted out by hand or by means of a robotic gripper (not shown). The additive manufacturing process ends when the three-dimensional object 70 is removed from the baseplate 14.

The support arrangement 12 can then be used again for additive manufacturing of a next three-dimensional object 70. while the produced three-dimensional object 70 is being post-processed remote from the additive manufacturing device 10. Such post-processing may comprise removal of the support structures 72 from the three-dimensional object 70, e.g. by means of polishing and/or CNC milling.

In this example, a machine learning agent is implemented in the control system 30. The machine learning agent is trained with training datasets containing parameters representative of the several additive manufacturing processes. The training datasets may for example comprise data indicative of different shapes of three-dimensional objects 70, different rotational speeds of the support elements 16, different translational speeds of the support elements 16, printing parameters, temperature data 68, and/or evaluation data from evaluations of printed three-dimensional objects 70.

In subsequent additive manufacturing processes, the movements of the support elements 16 are controlled by means of the machine learning agent. In this way, the movements of the support elements 16 can be improved, e.g. such that the three-dimensional objects 70 can be easily removed and/or with minimum surface deficiencies. For example, by learning how a particular rotational control of the support elements 16 will affect the support structures 72 for a particular type of three-dimensional object 70, the support structures 72 can be even further reduced in size. Thus, the support structures 72 do not have to provide an unnecessarily large margin against damage of the three-dimensional object 70. This in turn further reduces printing material consumption and further facilitates post-processing.

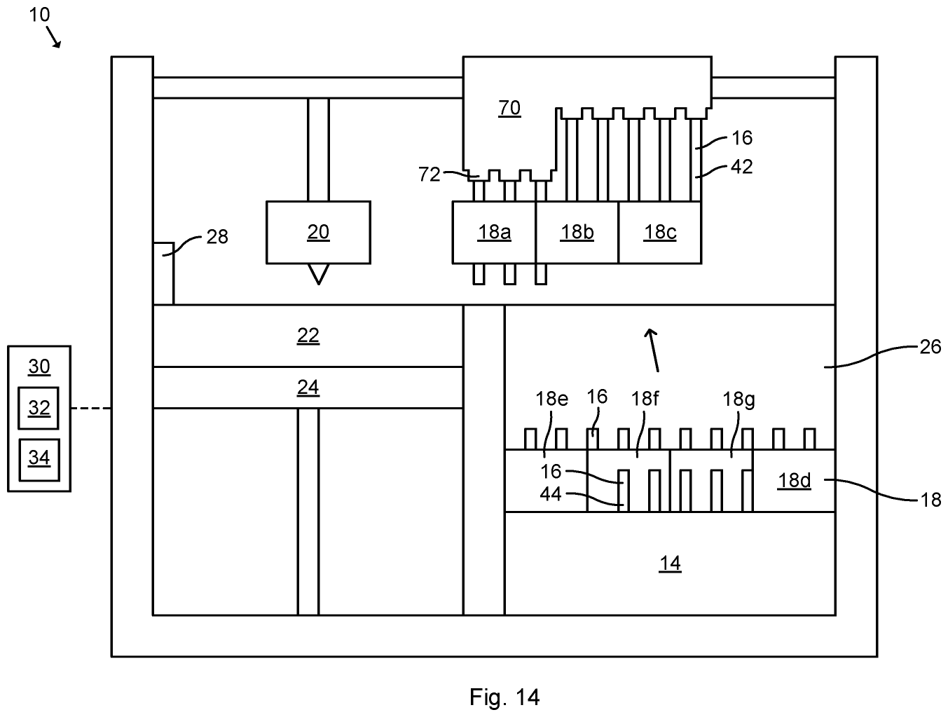

FIG. 14 schematically represents a side view of the additive manufacturing device 10 during removal of the three-dimensional object 70 together with intermediate structure units 18a-18c and the associated distal parts 42. The locking devices 60 associated with the support elements 16 of the intermediate structure units 18a-18c are commanded by the control system 30 to adopt the locking state such that the distal parts 42 are locked to the associated intermediate structure units 18a-18c. All actuators 46 remain in the baseplate 14 when the intermediate structure units 18a-18c are lifted off the baseplate 14.

This type of removal of the three-dimensional object 70 can be beneficial when the three-dimensional object 70 contain delicate parts that risk breaking by rotating the support elements 16. When the three-dimensional object 70 is being post-processed, a further additive manufacturing process may be performed using the remaining intermediate structure units 18d-18h and the associated support elements 16. For example, an identic three-dimensional object 70 may be printed while being supported by the support elements 16 of the intermediate structure units 18e-18g.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A support arrangement for additive manufacturing, the support arrangement comprising:
a base structure; and
a plurality of elongated support elements for supporting a three-dimensional object during additive manufacture of the three-dimensional object, each support element having a longitudinal axis and being independently movable relative to the base structure along the associated longitudinal axis;
wherein at least one of the support elements is rotatable about the associated longitudinal axis.

2. The support arrangement according to claim 1, wherein a plurality of the support elements are independently rotatable about the respective associated longitudinal axes.

3. The support arrangement according to claim 1, further comprising one or more temperature sensors configured to provide temperature data indicative of a temperature in one or more of the support elements.

4. The support arrangement according to claim 1, wherein each support element comprises an elongated distal part for supporting the three-dimensional object and an elongated proximal part supporting the distal part, the distal part being releasable from the proximal part.

5. The support arrangement according to claim 1, further comprising an intermediate structure having a through hole associated with each support element, wherein at least a part of the intermediate structure is configured to be removed from the base structure.

6. The support arrangement according to claim 5, further comprising a locking device associated with each support element, each locking device being configured to be engaged for locking the distal part to the intermediate structure.

7. The support arrangement according to claim 5, wherein the intermediate structure is modular and comprises a plurality of intermediate structure units.

8. An additive manufacturing device comprising a support arrangement including
a base structure, and
a plurality of elongated support elements for supporting a three-dimensional object during additive manufacture of the three-dimensional object, each support element having a longitudinal axis and being independently movable relative to the base structure along the associated longitudinal axis;
wherein at least one of the support elements is rotatable about the associated longitudinal axis.

9. The additive manufacturing device according to claim 8, when comprising a support arrangement according to claim 3, further including a control system having at least one data processing device and at least one memory having a computer program stored thereon, the computer program having program code which, when executed by the at least one data processing device, causes the at least one data processing device to perform the steps of:
receiving temperature data from the one or more temperature sensors; and
controlling movements of the support elements based on the temperature data.

10. A method of producing a three-dimensional object, the method comprising:
providing a support arrangement having a base structure and a plurality of elongated support elements for supporting the three-dimensional object, each support element having a longitudinal axis and being independently movable relative to the base structure along the associated longitudinal axis;
forming the three-dimensional object on the support elements by means of additive manufacturing in an additive manufacturing process;
moving one or more of the support elements along the associated longitudinal axis during the additive manufacturing process; and
rotating at least one of the support elements about the associated longitudinal axis.

11. The method according to claim 10, further comprising providing a machine learning agent, and controlling the rotation of the at least one support element by means of the machine learning agent.

12. The method according to claim 10, wherein the at least one support element is rotated to break a connection between the support element and the three-dimensional object.

13. The method according to claim 10, wherein the support arrangement further comprises one or more temperature sensors configured to provide temperature data indicative of a temperature in one or more of the support elements, wherein the method further includes controlling movements of the support elements based on the temperature data.

14. The method according to claim 10, wherein each support element comprises an elongated distal part for supporting the three-dimensional object and an elongated proximal part supporting the distal part, the distal part being releasable from the proximal part, and wherein the method further includes:
releasing one or more of the distal parts from the associated one or more proximal parts; and
removing the three-dimensional object together with the one or more released distal parts from the base structure.

15. The method according to claim 14, wherein the support arrangement further comprises an intermediate structure having a through hole associated with each support element, wherein the method further includes removing the three-dimensional object together with at least a part of the intermediate structure from the base structure.

16. The method according to claim 15, wherein the intermediate structure is modular and comprises a plurality of intermediate structure units, and wherein the method further includes removing the three-dimensional object together with one or more of the intermediate structure units from the base structure.

17. The method according to claim 10, wherein the at least one support element is simultaneously moved along, and rotated about, the associated longitudinal axis during the additive manufacturing process.

18. The support arrangement according to claim 2, further comprising one or more temperature sensors configured to provide temperature data indicative of a temperature in one or more of the support elements.

19. The support arrangement according to claim 2, wherein each support element comprises an elongated distal part for supporting the three-dimensional object and an elongated proximal part supporting the distal part, the distal part being releasable from the proximal part.

20. The support arrangement according to claim 2, further comprising an intermediate structure having a through hole associated with each support element, wherein at least a part of the intermediate structure is configured to be removed from the base structure.
